(19) United States
(12) Patent Application Publication
(10) Pub. No.: US 2014/0307188 A1
(43) Pub. Date: Oct. 16, 2014

(54) DISPLAY DEVICE

(71) Applicant: Sharp Kabushik Kaisha, Osaka-shi, Osaka (JP)

(72) Inventors: Ryoh Kikuchi, Osaka-shi (JP); Tomoo Takatani, Osaka-shi (JP); Hiroshi Fukushima, Osaka-shi (JP)

(21) Appl. No.: 14/354,212

(22) PCT Filed: Oct. 25, 2012
(86) PCT No.: PCT/JP2012/077625

§ 371 Date: Apr. 25, 2014

(30) Foreign Application Priority Data
Oct. 31, 2011 (JP) 2011-238229

(51) Int. Cl. G02B 27/22

(52) U.S. Cl. CPC G02B 27/2214
USPC 349/15

(57) ABSTRACT

In a display device in which a switching panel that displays a stripe image is provided on the viewing side of a main panel so that a three-dimensional image can be displayed, gap unevenness of the switching panel is made hardly visible, whereby appearance quality of the display device is improved. A liquid crystal display device includes: a main panel (2) that displays an image; a switching panel (3) that is provided on a viewing side of the main panel (2) and displays a stripe image as a parallax barrier so as to cause the image displayed on the main panel (2) to be viewed stereoscopically; a polarizing plate (4) that is provided on a viewing side of the switching panel (3) and converts incident light into linearly polarized light; and a retarder (7) that is provided between the switching panel (3) and the polarizing plate (4), converts linearly polarized light into circularly polarized light, and converts circularly polarized light into linearly polarized light.

### TECHNICAL FIELD

The present invention relates to a display device configured to cause an image displayed on a main panel to be viewed as a three-dimensional image by displaying a stripe image on a switching panel arranged on a viewing side of the main panel.

### BACKGROUND ART

Conventionally, a display device has been known that is capable of displaying an image three-dimensionally by a so-called parallax barrier method. Such a display device includes two liquid crystal panels arranged so as to face each other, as disclosed in, for example, JP5(1997)-122733A. The display device displays an image on one of liquid crystal panels, and displays a black-white barrier stripe image (stripe image) on the other liquid crystal panel. This causes the latter liquid crystal panel to function as a parallax barrier, thereby causing an image displayed on the former liquid crystal panel to be viewed as a three-dimensional, stereoscopic image. It should be noted that JP5(1997)-122733A discloses a configuration in which the barrier stripe image is displayed on the liquid crystal panel arranged on the viewing side, among the two liquid crystal panels.

### DISCLOSURE OF INVENTION

Incidentally, as mentioned above, the panel arranged on the viewing side includes a pair of substrates, and a sealing part that is arranged between outer circumferences of the substrates in a state in which they are stacked on one another. Further, in panel, spacers are arranged between the substrates in pair, so that the distance between the substrates should be uniform in in the surface direction.

In a panel having a configuration as described above, however, in the case where the distance (gap) between the substrates in pair is non-uniform in the surface direction, this is viewed as gap unevenness in some cases. Particularly in the case where the panel arranged on the viewing side has non-uniformity of gap, this is made easily visible as gap unevenness, by reflection light of light incident from the viewing side.

It is an object of the present invention to provide a display device in which a switching panel that displays a stripe image is provided on the viewing side of a main panel so that a three-dimensional image can be displayed, the display device being characterized in that gap unevenness of the switching panel is made hardly visible, whereby appearance quality of the display device is improved.

A display device according to one embodiment of the present invention includes: a main panel that displays an image; a switching panel that is provided on a viewing side of the main panel and displays a stripe image as a parallax barrier so as to cause the image displayed on the main panel to be viewed stereoscopically; a polarizing plate that is provided on a viewing side of the switching panel and converts incident light into linearly polarized light; and a retarder that is provided between the switching panel and the polarizing plate, converts linearly polarized light into circularly polarized light, and converts circularly polarized light into linearly polarized light.

According to one embodiment of the present invention, in a display device in which a switching panel that displays a stripe image is arranged on the main panel on the viewing side thereof so that three-dimensional images can be displayed, gap unevenness of the switching panel can be made hardly visible. As a result, the appearance quality of the display device can be improved.

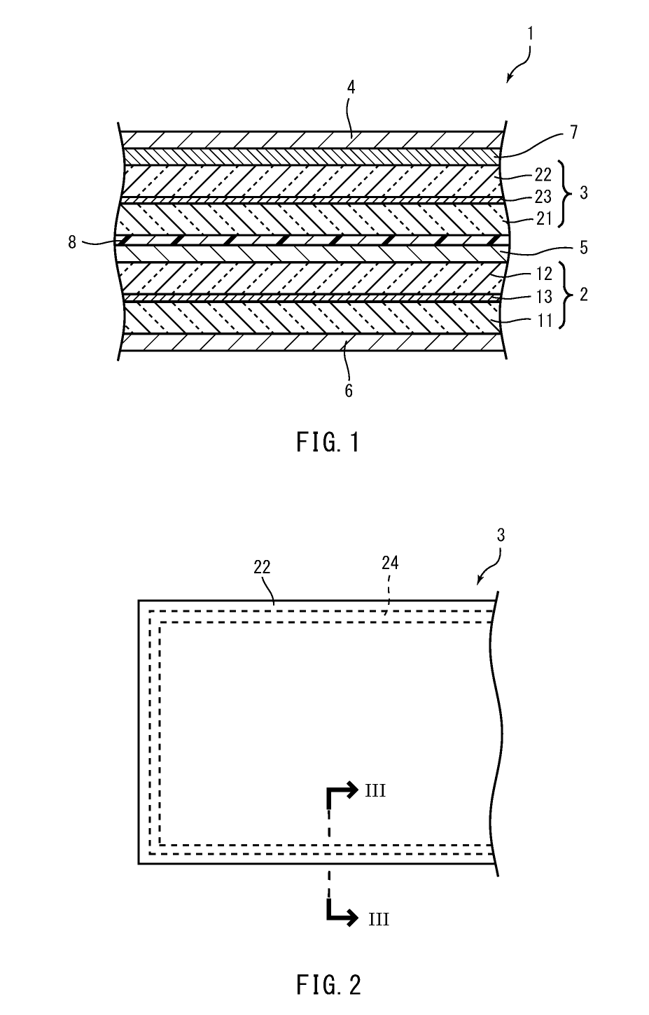

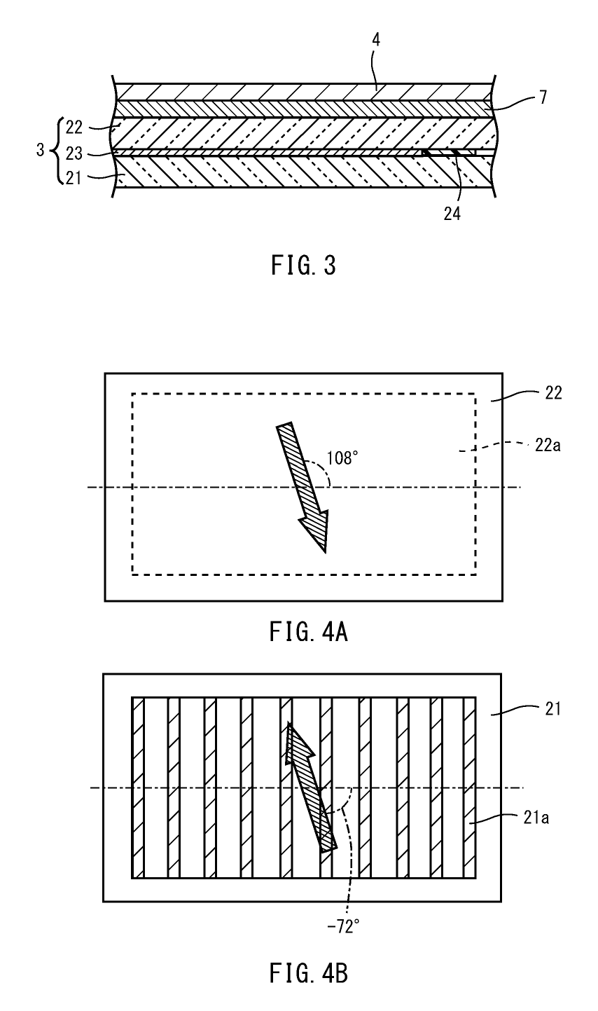

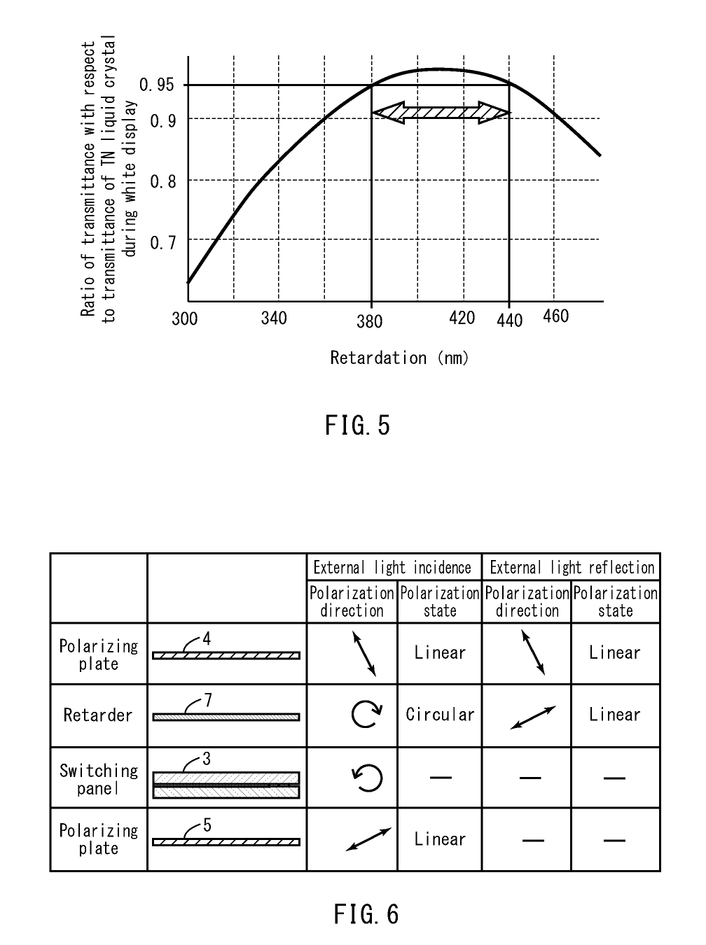

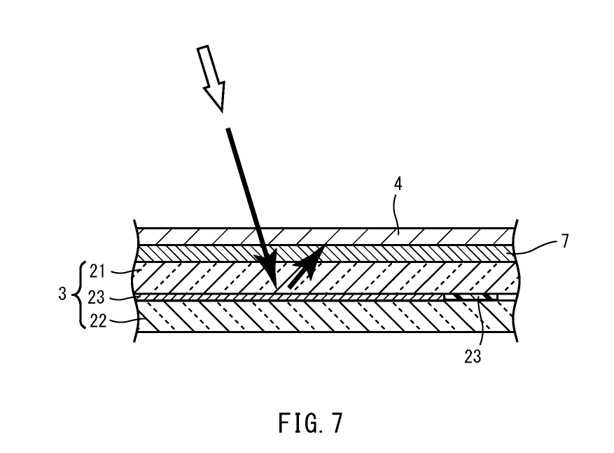

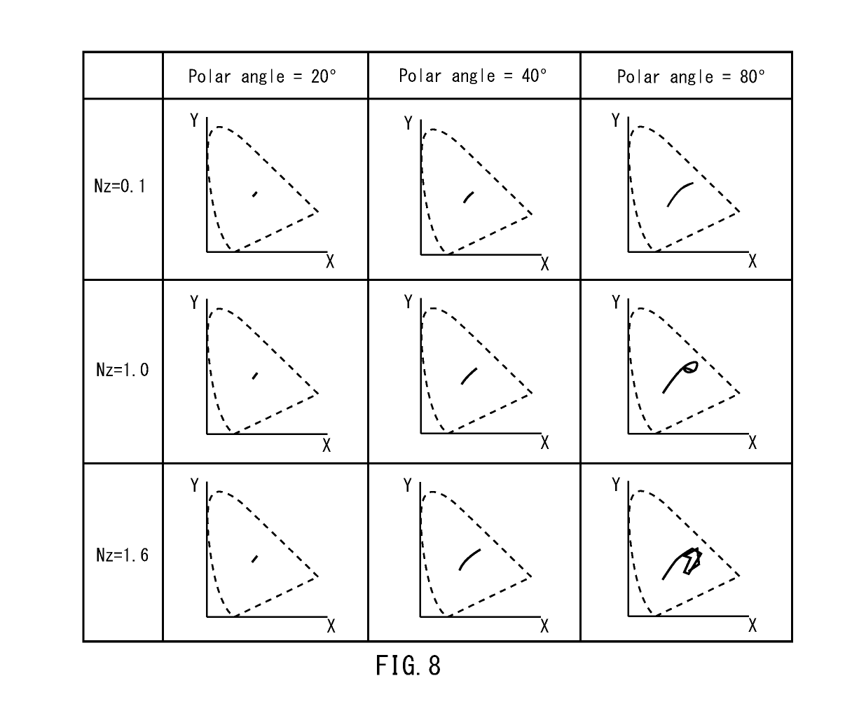

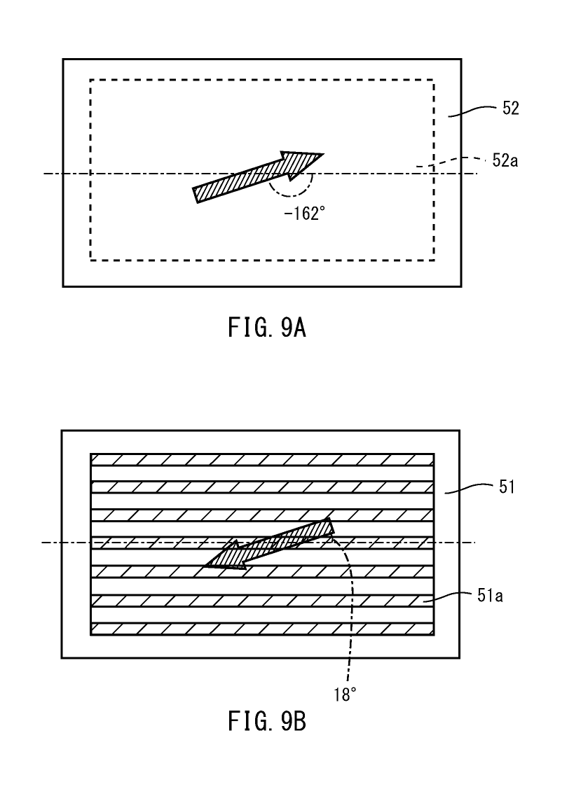

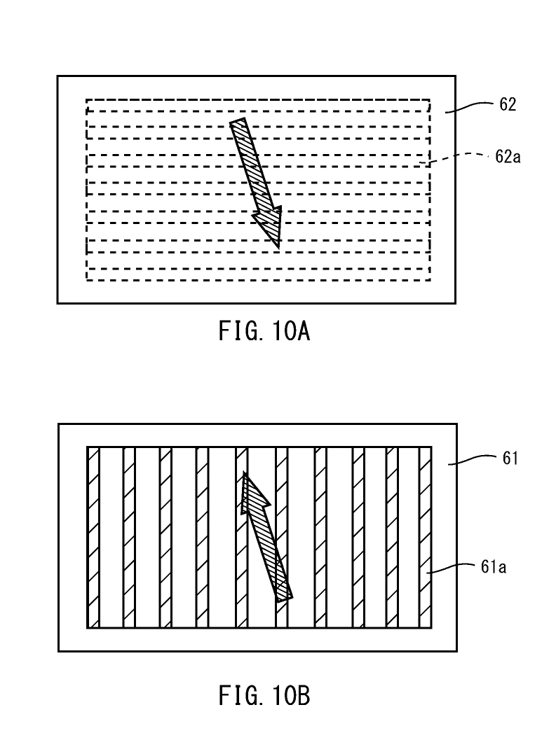

### BRIEF DESCRIPTION OF DRAWINGS

[FIG. 1] FIG. is a cross-sectional view illustrating a schematic configuration of a panel unit of a display device according to Embodiment 1 of the present invention.

[FIG. 2] FIG. 2 is a plan view illustrating arrangement of a sealing part of a switching panel.

[FIG. 3] FIG. 3 is a cross-sectional view taken along a line III-III in FIG. 2.

[FIG. 4A] FIG. 4A is a plan view illustrating a schematic configuration of a counter substrate of the switching panel.

[FIG. 4B] FIG. 4B is a plane view illustrating respective schematic configurations of substrates of the switching panel.

[FIG. 5] FIG. 5 is a graph showing the relationship between retardation and relative transmittance in the switching panel.

[FIG. 6] FIG. 6 illustrates polarization states of light incident from the viewing side and light reflected by the switching panel

[FIG. 7] FIG. 7 is a cross-sectional view illustrating how the light reflected by the switching panel is blocked by a polarizing plate.

[FIG. 8] FIG. 8 illustrates change in chromaticity of the display device when Nz of a retarder and a polar angle are varied.

[FIG. 9A] FIG. 9A is a diagram equivalent to FIG. 4A, about a switching panel of a display device according to Embodiment 2.

[FIG. 9B] FIG. 9B is a diagram equivalent to FIG. 4B, about the switching panel of the display device according to Embodiment 2.

[FIG. 10A] FIG. 10A is a diagram equivalent to FIG. 4A, about the switching panel of the display device according to Embodiment 3.

[FIG. 10B] FIG. 10B is a diagram equivalent to FIG. 4B, about the switching panel of the display device according to Embodiment 3.

### DESCRIPTION OF PREFERRED EMBODIMENTS

A display device according to one embodiment of the present invention includes: a main panel that displays an image; a switching panel that is provided on a viewing side of the main panel and displays a stripe image as a parallax barrier so as to cause the image displayed on the main panel to be viewed stereoscopically; a polarizing plate that is provided on a viewing side of the switching panel and converts incident light into linearly polarized light; and a retarder that is provided between the switching panel and the polarizing plate, converts linearly polarized light into circularly polarized light, and converts circularly polarized light into linearly polarized light (the first configuration).

The above-described configuration makes it possible to control visibility of gap unevenness so that it is hardly visualized by light incident from the viewing side, even in the case where gap unevenness occurs to the switching panel arranged on the viewing side of the main panel.

More specifically, on the viewing side of the switching panel, there are arranged a polarizing plate that converts incident light into linearly polarized light, and a retarder that converts linearly polarized light into circularly polarized light, and converts circularly polarized light in to linearly polarized light. With this, light incident from the viewing side is converted into linearly polarized light by the polarizing plate, and thereafter, it is converted into circularly polarized light by the retarder. Then, circularly polarized light, which is reflected by the switching panel and has an electric field vector whose rotation direction is reversed, is again incident to the retarder. The light is polarized by the retarder into linearly polarized light that has an electric field vector whose oscillation direction is 90 degrees different from the polarization direction of the polarizing plate. This linearly polarized light is blocked by the polarizing plate. Thus, light that is incident from the viewing side and is reflected by the switching panel is blocked by the polarizing plate. As a result, gap unevenness occurring to the switching panel can be made hardly visible from a viewer.

Therefore, with the configuration mentioned above, the appearance quality of the display device can be improved.

In the first configuration described above, the switching panel includes a pair of substrates, a display medium provided between the pair of substrates, and a sealing part for sealing the display medium between the pair of substrates, and the polarizing plate and the retarder are provided so as to cover the viewing side of the sealing part (the second configuration).

In a switching panel, the distance between the pair of substrates in the vicinities of the sealing part and the distance therebetween at the center thereof, when viewed in a plan view, are different in many cases. In other words, in a switching panel, gap unevenness tends to be easily visible in the vicinities of the sealing part. Therefore, by providing the polarizing plate and the retarder so that they cover the viewing side of the sealing part of the switching panel, light that is incident from the viewing side and reflected can be blocked at the vicinities of the sealing part. This makes gap unevenness that occurs in the vicinities of the sealing part of the switching panel hardly visible to a viewer.

In the second configuration described above, a comb-shaped electrode is provided on at least one of the pair of substrates in the switching panel (the third configuration). A switching panel having such a configuration is, in many cases, a panel having a simple configuration in which spacers are arranged between a pair of substrates to surely provide a distance between the substrates. Therefore, in the case of the switching panel having the above-described configuration, the distance between the pair of substrates tend to be non-uniform, and gap unevenness tends to occur. In contrast, by applying the first and second configurations mentioned above, gap unevenness, even if occurring to the switching panel, can be made hardly visible.

In any one of the first to third configurations, the retarder is arranged only on the viewing side of the switching panel (the fourth configuration). This makes it possible to block only light that is incident from the viewing side of the switching panel and is reflected by the switching panel, by using the polarizing plate and the retarder.

In any one of the first to fourth configurations, the retarder has Nz smaller than 1 (the fifth configuration). In the case where light is converted into circularly polarized light in the display device, viewing angle direction dependency is greater, as compared with the case where light is converted into linearly polarized light. Therefore, change in hue is greater depending on the direction in which a viewer views the display device. Therefore, by setting the Nz of the retarder to be smaller than Nz of a retarder typically used in a liquid crystal panel (having Nz of 1 or greater) as mentioned above, change in hue according to the viewing direction can be suppressed. Therefore, in the display device, decreases in display quality that occur when light is converted into circularly polarized light can be suppressed.

In any one of the first to fifth configurations, the switching panel has retardation of 380 nm to 440 nm (the sixth configuration). This makes it possible to increase transmittance of the switching panel. Therefore, this makes it possible to improve display quality in the case where a three-dimensional image is displayed using the switching panel.

Hereinafter, preferred embodiments of a display device of the present invention are described with reference to the drawings. It should be noted that the dimensions of the members shown in the drawings do not faithfully reflect actual dimensions of the constituent members, dimensional ratios of the constituent members, etc.

### Embodiments 1

### (Overall Configuration)

FIG. 1 illustrates a schematic configuration of a panel module 1 of a liquid crystal display device (display device) according to one embodiment of the present invention. This panel module 1 is composed of a plurality of members stacked in the thickness direction. More specifically, the panel module 1 includes a main panel 2 for displaying an image, a switching panel 3 for displaying a slit-like black-white image (stripe image), and three polarizing plates 4, 5, and 6 that are arranged with the main panel 2 and the switching panel 3 being interposed therebetween. The switching panel 3 is positioned on the viewing side of the main panel 2. It should be noted that, though not shown particularly, a backlight is provided on a back face of the panel module 1 (the side opposite to the viewing side).

As illustrated in FIG. 1, in the panel module 1, the polarizing plate 4, the retarder 7, the switching panel 3, the polarizing plate 5, the main panel 2, and the polarizing plate 6 are stacked in the order from the viewing side (the upper side as viewed in FIG. 1). Further, in the panel module 1, the switching panel 3 and the main panel 2 having the polarizing plate 5 attached thereto are bonded using a bonding agent 8. This causes the switching panel 3 and the main panel 2 to be provided integrally.

The liquid crystal display device according to the present embodiment is a so-called parallax barrier type three-dimensional image display device in which a parallax barrier is formed by displaying a stripe image on the switching panel 3 so that, among images displayed on the main panel 2, an image for the right eye is visible to only the right eye, and an image for the left eye is visible to only the left eye. Therefore, the main panel 2 displays the left eye image and the right eye image on one screen in synchronization with the display of the stripe image of the switching panel 3. It should be noted that, in the case where the liquid crystal display device according to the present embodiment is used as a display device for displaying a two-dimensional image, the driving of the switching panel 3 is stopped so that the switching panel 3 is made transparent.

The main panel 2 is, for example, a VA (vertical alignment)-type liquid crystal panel. The main panel 2 includes an active matrix substrate 11 on which a multiplicity of pixels are arrayed in matrix, and a counter substrate 12 that faces the active matrix substrate 11. Further, the main panel 2 includes a liquid crystal layer 13 arranged between the active matrix substrate 11 and the counter substrate 12. The liquid crystal layer 13 is capable of switching a state of causing birefringence of light and a light transmission state from one to the other.

The active matrix substrate 11 has such a configuration that on a transparent substrate such as a glass substrate, a plurality of TFTs (thin film transistors, not shown), pixel electrodes and a plurality of lines (source lines, gate lines, etc.) are provided. It should be noted that the configuration of a TFT is the same as a conventional configuration, and therefore, detailed description of the same is omitted herein.

The pixel electrodes are transparent electrodes, and are formed with a conductive material having light transmissivity such as ITOs (indium tin oxide). The pixel electrodes are arranged pixel by pixel, separated from one another. Pixels as units of image display are defined by these pixel electrodes.

Source electrodes, gate electrodes, and drain electrodes of the TFTs are connected to the source lines, the gate lines, and the pixel electrodes, respectively, though they are not shown specifically. The configuration in which signals are input to the TFTs via the gate lines and the source lines so as to drive the TFTs is the same as that for a conventional liquid crystal display device, and detailed explanation of the same is omitted herein.

The counter substrate 12 has such a configuration that a counter electrode made of a transparent conductive film such as an ITO film or the like is provided on a transparent substrate such as a glass substrate. Besides, on the counter substrate 12, color filters of RGB are provided.

In the main panel 2 having a configuration as described above, the state of the liquid crystal layer 13 can be switched pixel by pixel between the state of transmitting light and the state of causing birefringence of light, by controlling electric fields applied to the liquid crystal layer 13, that is, by controlling voltages applied across the counter electrode and the pixel electrodes. In other words, the application of electric fields to the liquid crystal layer is controlled by the TFTs, whereby areas that are colored by the color filters with light transmitted through light transmission regions in the liquid crystal layer 13 are displayed as a color image.

It should be noted that in the present embodiment, the color filters are provided on the counter substrate 12, but the configuration is not limited to this. The configuration may be without color filters.

### (Switching Panel)

The switching panel 3 includes a substrate 21, and a counter substrate 22 that faces the substrate 21, as illustrated in FIGS. 1, 3, 4A, and 4B. As illustrated in FIG. 4B, on the substrate 21, there is formed a comb-shaped electrode 21a that has a plurality of slits that extend in one direction of the substrate 21 (a direction along the short side of the substrate 21 in the example illustrated in FIG. 4B). On the other hand, on the counter substrate 22, there is formed a common electrode 22a that has a rectangular shape smaller than the counter substrate 22. Further, the switching panel 3 includes a liquid crystal layer 23 between the substrate 21 and the counter substrate 22, as illustrated in FIGS. 1 and 3. The liquid crystal layer 23 is capable of switching a state that causes light to optically rotate and a light transmission state from one to the other.

In the switching panel 3, as illustrated in FIGS. 2 and 3, a sealing part 24 is provided between the substrate 21 and the counter substrate 22, along their outer circumference sides. This sealing part 24 is made of, for example, an epoxy resin, and is provided along outer circumferences of the substrate 21 and the counter substrate 22. By providing the sealing part 24 between the substrate 21 and the counter substrate 22, a sealed space can be formed between the substrate 21 and the counter substrate 22. Liquid crystal (display medium) is sealed in this space, whereby the above-described liquid crystal layer 23 is formed.

In the switching panel 3, a plurality of spacers (not shown) are arranged inside the sealing part 24 so that the distance between the substrate 21 and the counter substrate 22 is uniform in the surface direction. As is described below, in the switching panel 3, even in the case where the spacers are provided between the substrate 21 and the counter substrate 22 in this way, it is difficult to make the distance between the substrate 21 and the counter substrate 22 uniform in the surface direction, and hence, the distance varies.

Further, though not shown in the drawings particularly, alignment films are provided on the liquid crystal layer 23 side surfaces of the substrate 21 and the counter substrate 22 of the switching panel 3. Surfaces of these alignment films are subjected to a rubbing treatment for rubbing a surface in one direction with cloth the like. Applying a rubbing treatment to the alignment films in this way makes it possible to align liquid crystal molecules in the liquid crystal layer 23 in a uniform direction. In the present embodiment, the alignment films of the substrate 21 and the counter substrate 22 are rubbed in such a manner that the rubbing direction of the alignment film provided on the substrate 21 and the rubbing direction of the alignment film provided on the counter substrate 22 are parallel with each other, as viewed from the viewing side.

FIGS. 4A and 4B show respective rubbing directions of the substrate 21 and the counter substrate 22, which are indicated by hatched arrows. In the example illustrated in FIG. 4B, with a line (dashed-dotted line) extending in the lateral direction being assumed to be a reference line of 0 degree and 180 degrees, the rubbing direction of the alignment film on the substrate 21 side is tilted by 72 degrees in the clockwise direction (−72 degrees in FIG. 4B). On the other hand, as illustrated in FIG. 4A, the rubbing direction of the alignment film on the counter substrate 22 is 180 degrees different from the rubbing direction of the alignment film on the substrate 21 (108 degrees in FIG. 4A).

In this way, the alignment films of the substrate 21 and the counter substrate 22, which have the liquid crystal layer 23 interposed therebetween, are subjected to rubbing treatments in such a manner that the rubbing directions thereof are parallel with each other, whereby liquid crystal molecules in the liquid crystal layer 23 can be arranged so that long axis directions thereof are directed in the same direction.

It should be noted that the substrate 21 of the switching panel 3 may have any configuration as long as it is such a configuration that a stripe image can be displayed on the switching panel 3, like the configuration of an active matrix substrate on which a multiplicity of pixels are arrayed in matrix, for example.

The switching panel 3 according to the present embodiment is preferably configured so that liquid crystal of the liquid crystal layer 23 has retardation dΔN (cell thickness×birefringent index) of 380 nm to 440 nm. Here, when the retardation of the switching panel 3 is varied, the ratio of transmittance of the switching panel 3 with respect to transmittance of TN liquid crystal performing white display (hereinafter referred to as relative transmittance) has characteristics as illustrated in FIG. 5. As illustrated in FIG. 5, the relative transmittance is maximized when the retardation of the switching panel 3 is about 410 nm, and forms a parabola that has a maximum value of the relative transmittance when the retardation is about 410 nm. In order to obtain a contrast close to that of the TN liquid crystal under such properties, a range of retardation at which the relative transmittance is 95% or more (a range of 380 nm to 440 nm, that is, the range indicated by an arrow in FIG. 5) is preferable.

The polarizing plates 4, 5, and 6 illustrated in FIG. 1 are configured to allow only a component in a specific direction to pass therethrough, among respective direction components of light. In other words, the polarizing plates 4, 5, and 6 are configured to convert the incidence light into linearly polarized light. The polarizing plates 5 and 6 have absorption axes according to the properties of the main panel 2 in order to convert light passing through the main panel 2 into linearly polarized light. The polarizing plate 4 has an absorption axis according to the properties of the switching panel 3 in order to convert light passing through the switching panel 3 into linearly polarized light.

In the case of the present embodiment, the polarizing plate 6 arranged on the viewing side of the switching panel 3 is configured so that the angle of the absorption axis is, for example, 63 degrees. The polarizing plate 5, arranged on the main panel 2, on the switching panel 3 side thereof, is configured so that the angle of the absorption axis is, for example, 153 degrees. Here, an angle of an absorption axis tilted toward the anticlockwise direction with respect to the horizontal direction, when the panel is viewed from the viewing side, is regarded as an angle of a positive value.

As illustrated in FIG. 1, the retarder 7 is provided between the polarizing plate 4 positioned on the viewing side of the panel unit 1, and the switching panel 3. This retarder 7 is configured to convert incident linearly polarized light into circularly polarized light, and on the other hand, when circularly polarized light is incident, convert the circularly polarized light into linearly polarized light. In other words, the retarder 7 is a λ/4 retarder that is capable of shifting phases of two polarization components that are orthogonal to each other so that the a phase difference between the two components is 1/4 wavelength. The absorption axis of this retarder 7 is tilted 45 degrees toward the clockwise direction with respect to the absorption axis of the polarizing plate 4, when the panel unit 1 is viewed from the viewing side. By shifting the absorption axis of the retarder 7 with respect to the absorption axis of the polarizing plate 4 so that the angle therebetween is 45 degrees, the retarder 7 is caused to convert linearly polarized light into circularly polarized light that has an electric field vector circularly rotating.

It should be noted that, as is described below, the retarder 7 is preferably configured so that the parameter Nz(=(ns−nz)/(ns−nf)), which represents the degree of biaxiality of the birefringent layer, is smaller than 1.0. Here, in the above-described expression of Nz, nz represents a refractive index of the retarder 7 in the thickness direction, ns represents a refractive index in the slow axis direction, and of represents a refractive index in the fast axis direction.

By arranging the polarizing plate 4 and the retarder 7 in this order from the viewing side as described above, as shown in the column of “External light incidence” in FIG. 6, it is possible to convert light incident from the viewing side into linearly polarized light by the polarizing plate 4, and to convert the linearly polarized light into circularly polarized light by the retarder 7. Light reflected by the switching panel 3 is incident as circularly polarized light to the retarder 7, and therefore, it is converted into linearly polarized light by the retarder 7, as shown in the column of “External light reflection” of FIG. 6.

Incidentally, in the switching panel 3, a distance (gap) is provided between the substrate 21 and the counter substrate 22, by providing the sealing part 24 and spacers (not shown) between the substrate 21 and the counter substrate 22, as described above. In the switching panel having such a configuration, it is difficult to make the dimension in the thickness direction uniform with the sealing part 24 and the spacers alone. Therefore, the gap tends to vary, in the center part and in the vicinities of the sealing part 24 when viewed in a plan view of the switching panel 3. This causes gap unevenness to be easily visible in the vicinities of the sealing part 24 of the switching panel 3 positioned on the viewing side, when a viewer views the panel unit 1. This is because light incident from the viewing side is reflected by the switching panel 3 and the reflected light is viewed by the viewer.

Particularly in the case where the main panel 2 and the switching panel 3 are bonded with the bonding material 8, a tensile force is exerted to the outer circumference side portion of the switching panel 3 in the surface direction when the bonding material 8 is dried. Then, the gap varies on the outer circumference side of the switching panel 3, which makes the gap unevenness more easily visible in the vicinities of the sealing part 24.

In contrast, by providing the polarizing plate 4 and the retarder 7 on the viewing side of the switching panel 3, in this order from the viewing side, as in the configuration of the present embodiment, light that is incident from the viewing side and is reflected by the switching panel 3 can be blocked by the retarder 7 and the polarizing plate 4 (see FIG. 7). More specifically, as mentioned above, the light incident from the viewing side of the panel unit 1 is converted by the polarizing plate 4 into linearly polarized light, and thereafter, it is converted by the retarder 7 into circularly polarized light (see FIG. 6). Here, light is converted by the retarder 7 into circularly polarized light that has an electric field vector rotating in the clockwise direction. Then, the light converted into circularly polarized light is reflected by the switching panel 3, converted into circularly polarized light that has an electric field vector rotating in the anticlockwise direction, and is incident to the retarder 7. This retarder 7 converts the circularly polarized light, which has an electric field vector rotating in the anticlockwise direction, into linearly polarized light that is polarized in a polarization direction 90 degrees different from that of the linearly polarized light obtained by the polarizing plate 4. As a result, the linearly polarized light obtained by conversion by the retarder 7 is blocked by the polarizing plate 4.

Therefore, with the above-described configuration, light that is incident from the viewing side of the panel unit 1 and reflected by the switching panel 3 is blocked by the polarizing plate 4 and the retarder 7. As a result, it is possible to prevent gap unevenness of the switching panel 3 from being viewed by a viewer.

In the case where circularly polarized light is used as described above, viewing angle direction dependency is greater, as compared with a panel using linearly polarized light. Therefore, in some cases, hue significantly changes, depending on the viewing angle direction. FIG. 8 shows change in chromaticity in the case where a polar angle (an angle tilted toward the panel side with respect to the normal line direction of the panel) is changed. It should be noted that FIG. 8 shows change in chromaticity when the panel unit 1 is viewed from all directions with the polar angle being varied in the case where Nz of the retarder 7 is varied so that Nz=0.1, 1.0, 1.6. Further, in each graph shown in FIG. 8, the chromaticity coordinate X is plotted along the horizontal axis, and the chromaticity coordinate Y is plotted along the longitudinal axis.

As is clear from FIG. 8, as the polar angle increases, change in the chromaticity increases, and the hue changes significantly. Further, as Nz of the retarder 7 is smaller, the change in chromaticity when the polar angle is large (80 degrees in the examples illustrated in FIG. 8) decreases. In other words, as Nz of the retarder 7 is smaller, the change in hue can be suppressed more. Particularly, in the case where Nz of the retarder 7 is smaller than Nz (Nz=1) of a retarder used in a common liquid crystal display device, change in hue can be suppressed further even if the polar angle increases.

Next, the switching between the two-dimensional display and the three-dimensional display of the panel unit 1 having the above-described configuration is described below.

In the case of the two-dimensional display, which is in a state in which no voltage is applied to the liquid crystal layer 23 of the switching panel 3, the phase of light can be changed by λ/2 by the retardation of the switching panel 3 and the retarder 7. As a result, light that is emitted from a backlight (not shown) and thereafter converted by the polarizing plates 5 and 6 into linearly polarized light. Then, the polarization direction of the linearly polarized light is changed by the switching panel 3 and the retarder 7 so that the polarization direction is parallel with the transmission axis of the polarizing plate 4. Light whose polarization direction is changed in this way passes through the polarizing plate 4 toward the viewing side. Thus, a viewer is allowed to view an image displayed on the main panel 2 as a two-dimensional image. It should be noted that the absorption axes of the polarizing plate 5 and the polarizing plate 7 are deviated from each other by 90 degrees, as mentioned above.

On the other hand, in the case of the three-dimensional display, since a voltage is applied to portions of the liquid crystal layer 23 of the switching panel 3 where the stripe image is displayed, liquid crystal molecules erect in the liquid crystal layer 23. Then, the switching panel 3 and the retarder 7 cause the light incident to the switching panel 3 to be incident to the polarizing plate 7, without any change in the polarization direction. With this, light is blocked by the polarizing plate 7 in the portions where a stripe image is to be displayed in the switching panel 3, which results in black display. In contrast, no voltage is applied to portions other than the portions where the stripe image is displayed in the liquid crystal layer 23 of the switching panel 3, and therefore, as is the case with the mentioned above two-dimensional display, light passes through the polarizing plate 7. With the above-described configuration, a stripe image can be displayed on the switching panel 3.

### (Effects of Embodiment 1)

In the present embodiment, which has a configuration in which the switching panel 3 is arranged on the viewing side of the main panel 2, the polarizing plate 4 for converting incident light into linearly polarized light and the retarder 7 for converting the linearly polarized light into circularly polarized light are provided further on the viewing side with respect to the switching panel 3. With this configuration, even if light that is incident from the viewing side of the panel unit 1 is reflected by the switch panel 3, the reflected light can be blocked by the polarizing plate 4 and retarder 7. In other words, light incident from the viewing side of the panel unit 1 is converted by the polarizing plate 4 into linearly polarized light, and thereafter, it is converted by the retarder 7 into circularly polarized light. When the light is reflected by the switching panel 3, it is converted into circularly polarized light having an electric field vector rotating in an opposite direction. The circularly polarized light is converted by the retarder 7 into linearly polarized light that is polarized in a polarization direction that is 90 degrees different from the above-described linearly polarized light obtained by conversion by the polarizing plate 4. With this, the linearly polarized light obtained by conversion by the retarder 7 is blocked by the polarizing plate 4.

The above-described configuration makes gap unevenness hardly visible, the gap unevenness occurring owing to variation of gap between the substrate 21 and the counter substrate 22 in the switching panel 3. As a result, the appearance quality of the liquid crystal display device can be improved.

Further, in the case where circularly polarized light is used, change in hue of an image can be suppressed by setting Nz of the retarder 7 to a value smaller than 1. Thereby the display quality of the liquid crystal display device can be improved.

### Embodiment 2

FIGS. 9A and 9B illustrate schematic configurations of a substrate 51 and a counter substrate 52 in a switching panel of a liquid crystal display device according to Embodiment 2 of the present invention. In Embodiment 2, the switching panel has a configuration different from the configuration in Embodiment 1 described above. Hereinafter, configurations identical to those in Embodiment 1 are denoted by the same reference numerals and descriptions thereof are omitted, and only those different from Embodiment 1 are described.

In the present embodiment, the panel unit is used in a state in which long sides of a switching panel illustrated in FIGS. 9A and 9B are directed to a longitudinal direction. Therefore, on the substrate 51 of the switching panel, there is formed a comb-shaped electrode 51a that has a plurality of slits extending in the lengthwise direction of the switching panel. It should be noted that on the counter substrate 52, as is the case with the counter substrate 22 in Embodiment 1 described above, a rectangular common electrode 52a is formed.

In the switching panel of the present embodiment, rubbing directions of the substrate 51 and the counter substrate 52 are directions indicated by arrows in FIGS. 9A and 9B, respectively. In other words, in the example illustrated in FIG. 9B, with the dashed-dotted line extending in the lateral direction being assumed to be a reference line of 0 degree and 180 degrees, the rubbing direction of the alignment film on the substrate 51 side is tilted by 18 degrees in the anticlockwise direction. On the other hand, as illustrated in FIG. 9A, the rubbing direction of the alignment film of the counter substrate 52 side is 180 degrees different from the rubbing direction of the substrate 51 side (−162 degrees).

Therefore, in the above-described example, the retarder 7 arranged on the viewing side of the switching panel has an absorption axis tilted at an angle of −252 degrees, while the polarizing plate 4 arranged on the viewing side of the retarder 7 has an absorption axis tilted at an angle of −207 degrees.

In the above-described configuration as well, it is possible to convert light incident from the viewing side of the switching panel into linearly polarized light by the polarizing plate 4, and to convert the obtained linearly polarized light into circularly polarized light by the retarder 7. Then, the circularly polarized light reflected by the switching panel is converted by the retarder 7 into linearly polarized light that is polarized in a polarization direction that is 90 degrees different from that of the linearly polarized light obtained by the polarizing plate 4. In this way, the linearly polarized light obtained by conversion from circularly polarized light by the retarder 7 is blocked by the polarizing plate 4.

### (Effects of Embodiment 2)

In the present embodiment, the substrate 51 of the switching panel is provided with the comb-shaped electrode 51a having a plurality of slits that extend in the lengthwise direction. Further, the rubbing directions of the substrate 51 and the counter substrate 52 are set to, for example, 18 degrees and −162 degrees, respectively, as illustrated in FIGS. 9A and 9B. In such a configuration as well, the angle of the absorption axis of the retarder 7 provided on the viewing side of the switching panel and the angle of the absorption axis of the polarizing plate 4 provided further on the viewing side with respect to the retarder 7 may be set so as to have the same relationship with the rubbing direction of the counter substrate 52 as the relationship in Embodiment 1, whereby effects identical to those in Embodiment 1 can be achieved. In other words, in the present embodiment as well, light reflected by the switching panel can be blocked by the polarizing plate 4 and the retarder 7, and the gap unevenness of the switching panel can be made hardly visible.

### Embodiments 3

FIG. 10 illustrate a schematic configuration of a substrate 61 and a counter substrate 62 in a switching panel of a liquid crystal display device according to Embodiment 3 of the present invention. In Embodiment 2, the switching panel has a configuration different from the configuration in Embodiment 1 described above. Hereinafter, configurations identical to those in Embodiment 1 are denoted by the same reference numerals and descriptions thereof are omitted, and only those different from Embodiment 1 are described.

In the present embodiment, the panel unit is used in either a state in which long sides of the switching panel shown in FIG. 10 are positioned at top and bottom (the state shown in FIG. 10), or a state in which short sides thereof are positioned at top and bottom. In other words, the panel unit in the present embodiment is configured to display an image three-dimensionally even in the case where the long sides are positioned at top and bottom or at right and left.

On the substrate 61 of the switching panel, there is formed a comb-shaped electrode 61a that has a plurality of slits extending along the short sides of the switching panel. On the counter substrate 62, there is formed a comb-shaped electrode 62a that has a plurality of slits extending in the lengthwise direction of the switching panel. In other words, in the present embodiment, comb-shaped electrodes are formed on both of the substrate 61 and the counter substrate 62 of the switching panel, respectively. Besides, the comb-shaped electrode 61a formed on the substrate 61 and the comb-shaped electrode 62a formed on the counter substrate 62 cross orthogonally as viewed in the viewing direction of the switching panel.

With this configuration, in a state where the long sides of the switching panel are positioned at top and bottom (the state shown in FIG. 10), a stripe image can be obtained by using the comb-shaped electrode 61a on the substrate 61. On the other hand, in a state where the short sides of the switching panel are positioned at upper and lower sides, a stripe image can be obtained by using the comb-shaped electrode 62a on the counter substrate 62.

It should be noted that, the rubbing directions of the substrate 61 and the counter substrate 62 of the switching panel in the present embodiment are identical to those in Embodiment 1. Therefore, the angle of the absorption axis of the polarizing plate provided on the viewing side of the switching panel and the angle of the absorption axis of the retarder are also identical to those in Embodiment 1.

In the above-described configuration as well, it is possible to convert light incident from the viewing side of the switching panel by the polarizing plate 4 into linearly polarized light, and to convert the linearly polarized light by the retarder 7 into circularly polarized light. Then, the circularly polarized light reflected by the switching panel is converted by the retarder 7 into linearly polarized light that is polarized in a polarization direction that is 90 degrees different from the linearly polarized light obtained by the polarizing plate 4. In this way, the linearly polarized light obtained by conversion from circularly polarized light by the retarder 7 is blocked by the polarizing plate 4.

### (Effects of Embodiment 3)

In the present embodiment, the substrate 61 and the counter substrate 62 of the switching panel are provided with the comb-shaped electrodes 61a and 62a, respectively, which have a plurality of slits extending in directions that are orthogonal to each other, as viewed in the viewing direction of the switching panel. This makes three-dimensional display available whichever the orientation of the panel unit is, portrait or landscape. In such a configuration as well, as is the case with Embodiment 1, the polarizing plate 4 capable of converting incident light into linearly polarized light, and the retarder 7 capable of converting linearly polarized light into circularly polarized light are provided on the viewing side of the switching panel, whereby light reflected by the switching panel can be blocked. Therefore, gap unevenness of the switching panel can be made hardly visible.

### Other Embodiments

So far, the embodiments of the present invention have been explained, but the embodiments described above are merely examples for embodying the present invention. Therefore, the present invention is not limited to the embodiments descried above, and in embodying the present invention, any one of the above-described embodiments can be modified appropriately as long as it does not go beyond the spirit of the invention.

In each embodiment described above, a VA-type liquid crystal panel is used as the main panel. However, the main panel may be another-type liquid crystal panel such as an IPS (in-plane switching)-type or a TN-type liquid crystal panel.

In each embodiment described above, liquid crystal panels are used as the switching panel 3 and the main panel 2. However, any display panels other than liquid crystal panels may be used as the switching panel 3 and the main panel 2, as long as the configuration is such that two panels are used for making an image visible three-dimensionally.

### INDUSTRIAL APPLICABILITY

The display device of the present invention is applicable as a display device that has a switching panel on the viewing side of the main panel so as to be capable of displaying a three-dimensional image.

1. A display device comprising:
a main panel that displays an image;
a switching panel that is provided on a viewing side of the main panel and displays a stripe image as a parallax barrier so as to cause the image displayed on the main panel to be viewed stereoscopically;
a polarizing plate that is provided on a viewing side of the switching panel and converts incident light into linearly polarized light; and
a retarder that is provided between the switching panel and the polarizing plate, converts linearly polarized light into circularly polarized light, and converts circularly polarized light into linearly polarized light.

2. The display device according to claim 1,
wherein the switching panel includes a pair of substrates, a display medium provided between the pair of substrates, and a sealing part for sealing the display medium between the pair of substrates, and
the polarizing plate and the retarder are provided so as to cover the viewing side of the sealing part.

3. The display device according to claim 2, wherein a comb-shaped electrode is provided on at least one of the pair of substrates in the switching panel.

4. The display device according to claim 1, wherein the retarder is provided only on the viewing side of the switching panel.

5. The display device according to claim 1, wherein the retarder has Nz smaller than 1.0.

6. The display device according to claim 1, wherein the switching panel has retardation of 380 nm to 440 nm.
